(19) United States
(12) Patent Application Publication
(10) Pub. No.: US 2006/0077554 A1
(43) Pub. Date: Apr. 13, 2006

(54) Diffraction gratings for electromagnetic radiation, and a method of production

(76) Inventor: Harald Schenk, Dresden (DE)

Correspondence Address: FAY KAPLUN & MARCIN, LLP, 15O BROADWAY, SUITE 702, NEW YORK, NY, 10038, US

(21) Appl. No.: 11/240,065

(22) Filed: Sep. 30, 2005

(30) Foreign Application Priority Data
Oct. 8, 2004 (EP) 04 024 052.5

(51) Int. Cl. G02B 5/18

(52) U.S. Cl. 359/569

(57) ABSTRACT

Described are diffraction gratings for electromagnetic radiation and a method suitable for production. The diffraction gratings can be used, in particular, as microspectrometers which can be used in this case in the form of scanning microgratings. In accordance with the object set, they are to be made available as efficient diffraction gratings in miniaturized form and to be able to be produced cost-effectively and in large piece numbers. In the case of the diffraction gratings, there is constructed on a surface of a substrate a surface structure which is formed from equidistantly arranged linear structural elements aligned parallel to one another. Moreover, the entire surface of the substrate and of the structural elements is coated with at least one further layer, which forms a uniform surface contoured in the shape of a wave and having alternatively arranged wave peaks and wave troughs.

### FIELD OF INVENTION

The present invention relates to diffraction gratings for electromagnetic radiation, and to a method suitable for production. The diffraction gratings according to the present invention can be used, in particular, as microspectrometers which in this case can be used in the form of scanning microgratings.

### BACKGROUND INFORMATION

Such microspectrometers with pivotable diffraction gratings have been described, for example, by H. Grüger et al. in “Performance and Applications of a spectrometer with micromachined scanning grating”; Micromachining and Microfabrication, part of SPIE Photonic West (2203).

Very small micromechanical systems are desired for many applications, and there is also a consequent need for the diffraction gratings used in this case to be provided in a correspondingly small size. As already indicated, in this case, the diffraction gratings are pivoted about an axis of rotation, and so the electromagnetic radiation which is directed from a corresponding radiation source onto such a diffraction grating is guided sequentially in a spectral region over one or more detectors suitable for detecting specific wavelengths of the electromagnetic radiation.

High-precision and efficient diffraction gratings are usually produced by means of a moulding method from a so-called master, or else by means of holographic methods. Moulding from a master requires the latter to be produced in advance. This production is performed such that equidistant lines are constructed in a substrate which consists, for example, of a metal, this being done by means of a scoring tool. The moulding of such a master can then be performed, for example, by means of a cured plastic, for example, epoxy resin. Subsequent to the moulding, a metallic layer of high reflectivity can be applied to such a moulded structure.

However, it is problematic in this case that a substantial mechanical pressure is required for the moulding, and that substantial compressive forces act on the substrates, which are typically only a few 10 μm thick. Moreover, problems arise with the lateral adjustment accuracy required.

Moreover, the possible piece number of individual diffraction grating elements of such a master moulding is limited. There is thus, of course, an increase in the production costs of such diffraction gratings suitable for micromechanical applications.

Holographic methods for producing corresponding diffraction gratings are based on the interference principle with the use of laser radiation. Interference between component laser beams produces an incipiently sinusoidal intensity profile with the aid of which the photosensitive layer on a substrate with the corresponding interference pattern is illuminated. This interference intensity profile is then transferred onto the photosensitive layer after the exposure and subsequent development in topological form. The photosensitive layer can subsequently be coated with a highly reflective metal film.

However, it is not possible during production to use the plant engineering such as is normally used, for example, in mature form in semiconductor component fabrication, and so there is a need for an additional implementation in such plant engineering.

Moreover, it is known to produce diffraction gratings with appropriate surface topology by means of the process engineering, known per se, of grey-scale lithography. However, in this case the number/spacing of the individual lines of a diffraction grating is restricted, and so the spectral resolution of such a diffraction grating is likewise limited.

However, diffraction gratings can also be made available by means of a simple structuring of a reflecting layer applied to a substrate. A rectangular diffraction grating can be obtained to a first approximation in this case. However, the diffraction gratings thus produced have a low efficiency and can consequently be used only for spectral analysis with the aid of high-intensity sources for electromagnetic radiation.

### SUMMARY OF INVENTION

The present invention relates efficient diffraction gratings in miniaturized form which can be produced cost-effectively and in high piece numbers. In particular, described are diffraction gratings for electromagnetic radiation and a method suitable for production. The diffraction gratings according to the invention can be used, in particular, as microspectrometers which can be used in this case in the form of scanning microgratings. In accordance with the object set, they are to be made available as efficient diffraction gratings in miniaturized form and to be able to be produced cost-effectively and in large piece numbers. In the case of the diffraction gratings, there is constructed on a surface of a substrate a surface structure which is formed from equidistantly arranged linear structural elements aligned parallel to one another. Moreover, the entire surface of the substrate and of the structural elements is coated with at least one further layer, which forms a uniform surface contoured in the shape of a wave and having alternatively arranged wave peaks and wave troughs.

### BRIEF DESCRIPTION OF DRAWING

FIG. 1 shows a part of a diffraction grating, as reflection grating according to an exemplary embodiment of the present invention.

### DETAILED DESCRIPTION

According to the present invention, a diffraction grating which exhibits the features described below is utilized. The inventive diffraction gratings for electromagnetic radiation are constructed in this case such that a surface structure has been constructed on a surface of a substrate.

This surface structure comprises linear structural elements which are arranged equidistantly from one another and are, moreover, to be aligned parallel to one another. Consequently, the linear structural elements form elevations on the respective surface of the substrate.

In the entire surface of the substrate, that is to say also on the surfaces of the structural elements, at least one layer is then constructed which forms a uniform surface contoured in the shape of a wave and having alternatively arranged wave peaks and wave troughs, the wave peaks being arranged above the structural elements, and the wave troughs being arranged between the structural elements. Such an undulating surface contour is constructed in conjunction with the construction of the at least one layer independently of the surface contour of the individual structural elements, since a rounding effect can be utilized in the coating techniques which can be used when producing inventive diffraction gratings.

Thus, to a limited extent the cross-sectional geometry in which the structural elements are constructed on the respective surface of a substrate is not important. Thus, structural elements can have rectangular or else trapezoidal cross-sectional shapes with corresponding edge regions, while a virtually continuous undulating surface contour can be constructed nevertheless.

At least partially elliptical cross-sectional shapes of structural elements which can be constructed, for example, owing to underetching, to which we will revert again later below, can also be managed directly when constructing the undulating surface contour.

The at least one or more individual layer(s) constructed one above another should advantageously form a sinusoidal surface.

Particularly when inventive diffraction gratings are being used in a prescribed spectral region of electromagnetic radiation, the surface of the substrate on which the structural elements are arranged should be of flat and planar construction. Moreover, it is possible for the inventive diffraction gratings to be made available as transmission gratings or else as reflection gratings.

In the case of a transmission grating, at least one layer made from the respective substrate material should then be applied to a substrate which is transparent to the respective electromagnetic radiation region, and the undulating surface contour should be constructed with the aid of this at least one layer.

In the case of reflection gratings, such a layer can be formed from a material which reflects the respective electromagnetic radiation, in which case it is also possible for a number of such reflecting layers to be constructed one above another. It is thus possible, for example, to use highly reflective metals or metal alloys for such layers. Aluminium, silver, gold or a corresponding alloy thereof may be named here by way of example.

In the case in which a number of layers are to be constructed on the entire surface of an inventive diffraction grating, these need not necessarily be constructed from corresponding reflecting materials. Thus, it is possible to construct appropriate reflecting multilayer systems from alternatively arranged layers of in each case one substance with a higher and one substance with a lower optical refractive index. Such a multilayer system is then likewise to be formed in the position of a reflection grating.

However, it is also possible in this process to utilize interference, and for the respective layer thicknesses of such layers of multilayer systems to be constructed for prescribable wavelengths as so-called λ/4 layers in each case, the respective layer thicknesses then being required to have an integral multiple of λ/4 of an appropriately prescribed wavelength. Of course, in this case the respective angle of incidence of the corresponding electromagnetic radiation on the irradiated surface of the diffraction grating is a parameter which has to be taken into account.

The inventive diffraction gratings can be produced such that constructed on a surface of a substrate is a layer from which the already explained linear structural elements are formed by subsequent process steps. Such a layer can be a photoresist, for example, and structural elements can be formed on the surface of the substrate in the desired surface topology by means of a photolithographic process with subsequent etching. It is possible in this case to have recourse to conventional plant engineering such as is customarily used, for example, in the semiconductor industry. The etching can be carried out both with wet chemical methods and in the form of dry etching methods likewise known per se.

Thus, it is possible using current technology to obtain structuring with linear structural elements of more than 5000 on 1 mm.

As already addressed in general, a substrate pretreated in such a manner can then be coated with at least one layer which then forms the undulating surface contour. PVD or CVD methods known per se can be used for constructing the layer.

It is thus immediately possible to process a correspondingly large-format diffraction grating or a multiplicity of small-format diffraction gratings on a substrate at the same time in one engineering step in each case, it thereby being possible for the individual piece costs to be substantially reduced by comparison with conventional solutions.

The parameters of conventional sinusoidal diffraction gratings, and a corresponding spectral resolution, can be achieved directly with the aid of the inventive diffraction grating.

Structural elements 2 were constructed on the surface of a thin substrate 1 made from silicon, this being done photolithographically and after etching. The linear structural elements 2 aligned parallel to one another have a rectangular cross section in this example and a height h1 and a width d. The distances D and cross-sectional dimensions of the structural elements 2 are kept as identical as possible in each case.

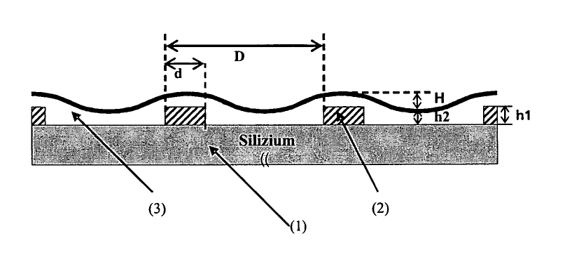

Subsequently, magnetron sputtering, for example, was used to construct a high-reflecting layer 3 made from aluminium on the entire surface of the substrate 1, that is to say also above the structural elements 2. The deposited layer 3 forms the undulating surface contour illustrated in FIG. 1, such that between the structural elements 2 there is a layer thickness h2 in valleys in the middle between two adjacent structural elements 2 and a height H above structural elements 2. A sinusoidal surface contour was achieved after construction of the layer 3.

What is claimed is:

1. A diffraction grating for electromagnetic radiation, comprising:
a substrate;
a surface structure mounted on a first surface of the substrate, the surface structure including a plurality of substantially linear structural elements substantially equidistant from one another and aligned parallel to one another; and
a first layer coating the first surface of the substrate and the structural element s, the first layer forming a substantially uniform surface contoured in a wave shape and having alternately arranged wave peaks and wave troughs.

2. The diffraction grating according to claim 1, wherein the first layer forms a substantially sinusoidal surface.

3. The diffraction grating according to claim 1, wherein the first surface of the substrate is a substantially planar area.

4. The diffraction grating according to claim 1, further comprising a second layer on the substrate, the second layer being composed of the same material as the substrate, the substrate being substantially transparent to electromagnetic radiation.

5. The diffraction grating according to claim 1, wherein the first layer reflects electromagnetic radiation.

6. The diffraction grating according to claim 5, wherein the first layer is formed of one of a highly reflective metal or a highly reflective metal alloy.

7. The diffraction grating according to claim 6, wherein the at least one layer is formed from aluminum, silver, gold or an alloy of silver, gold or aluminum.

8. The diffraction grating according to claim 1, wherein a number of layers form a multilayer system formed from alternatingly arranged layers of a substance with a higher or lower optical refractive index.

9. The diffraction grating according to claim 1, wherein the at least one layer has a layer thickness which corresponds to an integer multiple λ/4 of a prescribed wavelength λ.

10. The diffraction grating according to claim 1, wherein the structural elements have a cross section which is one of rectangular, trapezoidal and at least partially an elliptical shape.

11. A method for producing a diffraction grating, comprising:
applying a first layer to a first surface of a substrate;
structuring the first layer using photolithography and subsequent etching to form a plurality of substantially equidistant linear structural elements on the surface of the substrate; and
after the structuring step, coating the first surface of the substrate with a second layer to obtain a substantially uniform surface contoured in a wave shape.
